(19) United States
(12) Patent Application Publication
(10) Pub. No.: US 2026/0285319 A1
(43) Pub. Date: Sep. 24, 2026

(54) NON-TRANSITORY COMPUTER-READABLE STORAGE MEDIUM AND VEHICLE CONTROL SYSTEM

(71) Applicant: HONDA MOTOR CO., LTD., Tokyo (JP)

(72) Inventors: Masaaki TAKAHASHI, Tokyo (JP); Hirofumi AKAGI, Tokyo (JP)

(21) Appl. No.: 19/541,496

(22) Filed: Feb. 17, 2026

(30) Foreign Application Priority Data
Mar. 18, 2025 (JP) 2025-044080

(51) Int. Cl. B60W 30/18

(52) U.S. Cl. CPC B60W 30/18163; B60W 2554/804

(57) ABSTRACT

In adaptive cruise control, when there is a preceding vehicle traveling at a speed less than a predetermined set speed on a first lane on which an ego vehicle is traveling, following travel to follow the preceding vehicle is performed, and when there is no preceding vehicle on the first lane, constant speed travel to travel at the set speed is performed. In a case where, during the following travel, the preceding vehicle makes a lane change from the first lane to a second lane separated from the first lane by a lane marking, a computer accelerates the ego vehicle to transition to the constant speed travel on the first lane before an entirety of the preceding vehicle crosses the lane marking.

### TECHNICAL FIELD

The present invention relates to a vehicle control program (stored in a non-transitory computer-readable storage medium) for causing a computer to execute information processing including adaptive cruise control and a vehicle control system.

### BACKGROUND ART

In recent years, efforts have been actively made to provide access to sustainable transport systems that take into account people in vulnerable situations among traffic participants. To achieve this, research and development for further improving safety and convenience of traffic through development of driving assistance technologies is attracting attention.

For example, JP2009-1107A discloses a vehicle travel control device configured to perform control to follow a preceding vehicle. In the vehicle travel control device described in JP2009-1107A, when the preceding vehicle changes lanes and acceleration is to be made, the control state is released based on an operating state by the driver.

Further, for example, JP2001-347851A discloses an adaptive cruise control (ACC) device. During execution of the adaptive cruise control, the ego vehicle is controlled by the control device such that when there is no preceding vehicle, the ego vehicle travels at a set constant speed, and when there is a preceding vehicle traveling at a speed less than the set speed, the ego vehicle travels to follow the preceding vehicle. JP2001-347851A discloses a process related to shift down when the preceding vehicle becomes undetected due to a lane change or the like and the control is switched from the following travel to the constant speed travel.

Incidentally, in the invention described in JP2009-1107A, in order to accelerate after the preceding vehicle has made a lane change, it is necessary for the driver to operate an accelerator pedal or the like to release the control state. Also, in the invention described in JP2001-347851A, it is determined that the preceding vehicle has made a lane change when the preceding vehicle that has been detected becomes no longer detected. However, if the acceleration is started after it is determined that the preceding vehicle has disappeared from in front of the ego vehicle, the driver may feel discomfort, such as that the acceleration is slow to start or the acceleration starts abruptly.

### SUMMARY OF THE INVENTION

To solve the above problems and moreover to contribute to development of a sustainable transport system, an object of the present invention is to provide a vehicle control program (stored in a non-transitory computer-readable storage medium) and a vehicle control system which can suppress discomfort felt by the driver in a vehicle in which the adaptive cruise control is being executed.

To achieve the above object, one aspect of the present invention provides a non-transitory computer-readable storage medium comprising a vehicle control program, wherein the vehicle control program, when executed by a computer for controlling an ego vehicle, causes the computer to execute information processing including adaptive cruise control in which, when there is a preceding vehicle traveling at a speed less than a predetermined set speed on a first lane on which the ego vehicle is traveling, following travel to follow the preceding vehicle is performed, and when there is no preceding vehicle on the first lane, constant speed travel to travel at the set speed is performed, wherein the information processing comprises an acceleration step in which, in a case where, during the following travel, the preceding vehicle makes a lane change from the first lane to a second lane separated from the first lane by a lane marking, the computer accelerates the ego vehicle to transition to the constant speed travel on the first lane before an entirety of the preceding vehicle crosses the lane marking.

To achieve the above object, one aspect of the present invention provides a vehicle control system for controlling an ego vehicle provided with a propulsion device, a brake device, and a steering device, the vehicle control system comprising: an external environment recognizing device configured to detect an object around the ego vehicle; and a vehicle control device configured to control the propulsion device, the brake device, and the steering device based on information including detection results of the external environment recognizing device, wherein the vehicle control device is configured to be capable of executing, in the ego vehicle, adaptive cruise control in which, when there is a preceding vehicle traveling at a speed less than a predetermined set speed on a first lane on which the ego vehicle is traveling, following travel to follow the preceding vehicle is performed, and when there is no preceding vehicle on the first lane, constant speed travel to travel at the set speed is performed, and the vehicle control device is configured such that in a case where, during the following travel, the preceding vehicle makes a lane change from the first lane to a second lane separated from the first lane by a lane marking, the vehicle control device accelerates the ego vehicle to transition to the constant speed travel on the first lane before an entirety of the preceding vehicle crosses the lane marking.

According to the above aspect, a vehicle control program and a vehicle control system which can suppress discomfort felt by the driver in a vehicle in which the adaptive cruise control is being executed can be provided.

### BRIEF DESCRIPTION OF THE DRAWINGS

FIG. 1 is a block diagram of a configuration of a vehicle control system according to an embodiment;

FIG. 2 is a flowchart showing a flow of control according to the embodiment;

FIG. 3 is an explanatory diagram showing an ego vehicle and the surrounding thereof based on which the control according to the embodiment is performed;

FIG. 4 is a diagram showing a change of a state of a vehicle according to the embodiment; and

FIG. 5 is a diagram showing a change of first and second determination lines in the control according to the embodiment depending on a lateral speed of a preceding vehicle.

### DETAILED DESCRIPTION OF THE INVENTION

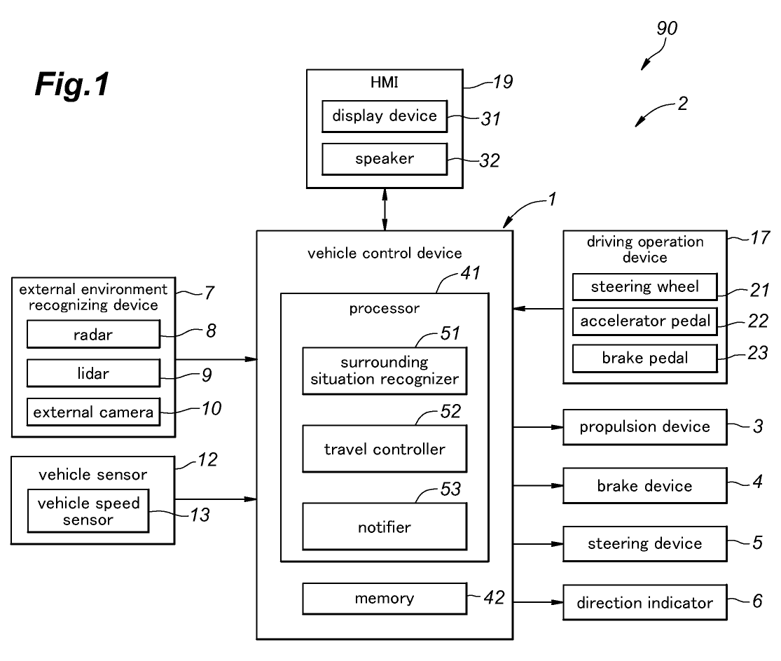

In the following, an embodiment of the present invention will be described with reference to the drawings. FIG. 1 is a block diagram showing a configuration of a vehicle control system 90 according to an embodiment. With reference to FIG. 1, the features of the vehicle control system 90 will be described.

As shown in FIG. 1, a vehicle control device 1 is provided in an ego vehicle 2. The ego vehicle 2 may be, for example, a four-wheeled automobile. The ego vehicle 2 is an autonomous vehicle or a vehicle with a driving assistance function.

The ego vehicle 2 includes a propulsion device 3, a brake device 4, and a steering device 5. The propulsion device 3 is a device that provides the driving force to the ego vehicle 2, and includes, for example, a power source and a transmission. The power source includes at least one of an internal combustion engine such as a gasoline engine or a diesel engine, and an electric motor. The brake device 4 is a device that applies the braking force to the ego vehicle 2, and includes, for example, a brake caliper that presses a pad against a brake rotor, and an electric cylinder that supplies hydraulic pressure to the brake caliper. The steering device 5 is a device for changing the steering angle of wheels, and includes, for example, a rack-and-pinion mechanism for steering the wheels, and an electric motor for driving the rack-and-pinion mechanism. The propulsion device 3, the brake device 4, and the steering device 5 are controlled by the vehicle control device 1.

The ego vehicle 2 includes a direction indicator 6. The direction indicator 6 includes lamps disposed on left and right parts of each of the front and rear faces of the ego vehicle 2. In response to an operation of the direction indicator lever (not shown in the drawings) by the driver or control by the vehicle control device 1, the left or right lamps of the direction indicator 6 are caused to blink according to the traveling direction.

The ego vehicle 2 includes an external environment recognizing device 7. The external environment recognizing device 7 is a device for detecting objects outside the vehicle and the like. The external environment recognizing device 7 is a sensor that captures electromagnetic waves and light from the surroundings of the ego vehicle 2 to detect the objects outside the ego vehicle 2. The external environment recognizing device 7 includes, for example, a radar 8, a lidar 9 (LiDAR), and an external camera 10.

The ego vehicle 2 includes a vehicle sensor 12. The vehicle sensor 12 includes a vehicle speed sensor 13 that detects the speed of the ego vehicle 2, an acceleration sensor that detects the acceleration thereof, a yaw rate sensor that detects the angular velocity around the vertical axis, an azimuth sensor that detects the orientation of the ego vehicle 2, and the like.

The ego vehicle 2 includes a driving operation device 17. The driving operation device 17 accepts input operations performed by the occupant (driver) to control the ego vehicle 2. The driving operation device 17 includes a steering wheel 21, an accelerator pedal 22, and a brake pedal 23. The driving operation device 17 may also include a shift lever, a parking brake lever, and the like. Each component of the driving operation device 17 is provided with a sensor that detects the operation amount. The driving operation device 17 outputs a signal indicating the operation amount to the vehicle control device 1.

The ego vehicle 2 includes an HMI 19. The HMI 19 notifies the occupant of various information by display and audio, and accepts input operations by the occupant. The HMI 19 includes a display device 31 and a speaker 32. The display device 31 may be a touch panel display including a liquid crystal display or an organic electroluminescence display. The display device 31 may also function as a navigation interface. The display device 31 and the speaker 32 function as notification devices for notifying the occupant by images and audio. Here, the image may be a video including a number of consecutive frames.

The vehicle control device 1 is a computer including a processor 41 and a memory 42 communicatively connected to the processor 41. The processor 41 may include at least one of the following cores: a central processing unit (CPU), a graphics processing unit (GPU), and a reduced instruction set computer (RISC). The memory 42 stores the control program executed by the processor 41 and various data. The memory 42 may include at least one of a volatile memory and a non-volatile memory. The volatile memory may be, for example, a dynamic random access memory (DRAM) or a static random access memory (SRAM). The non-volatile memory may be a solid state drive (SSD), a flash memory, a magnetic disk storage device, or an optical disk storage device. At least a portion of the vehicle control device 1 may be realized by hardware such as a large scale integration (LSI), an application specific integrated circuit (ASIC), or a field-programmable gate array (FPGA), or may be realized by a combination of software and hardware. The vehicle control device 1 may be composed of a single piece of hardware, or may be composed of plural pieces of hardware capable of communicating with each other. A portion of the vehicle control device 1 may be composed of an external server provided outside the ego vehicle 2.

The processor 41 realizes various applications by executing the control program stored in the memory 42. The control program may be stored in a removable recordable medium such as a DVD or a CD-ROM, and installed in the memory 42 as the recordable medium is read by a reading device. The control program may also be downloaded and installed in the memory 42 via a communication network such as the Internet.

By executing the control programs stored in the memory 42, the processor 41 functions as a surrounding situation recognizer 51, a travel controller 52, and a notifier 53. The processor 41 executes the control program, and the vehicle control device 1, which is a computer, executes the vehicle control method.

The surrounding situation recognizer 51 recognizes the surrounding situation of the ego vehicle 2. The surrounding situation recognizer 51 recognizes the surrounding situation (external environment), including obstacles located around the ego vehicle 2, the shapes of roads, the presence or absence of sidewalks, road markings, and the like, based on the detection results of the external environment recognizing device 7. The obstacles include, for example, guardrails, utility poles, surrounding vehicles, and people such as pedestrians. The surrounding situation recognizer 51 can acquire the position, speed, acceleration, and other states of the surrounding vehicles from the detection results of the external environment recognizing device 7.

The travel controller 52 is configured to control the acceleration and deceleration of the ego vehicle 2 according to the driving mode. The travel controller 52 may also be configured to control the steering of the ego vehicle 2 in addition to the acceleration and deceleration of the ego vehicle 2. The travel controller 52 executes driving assist control including adaptive cruise control (hereinafter referred to as ACC) and lane keeping assist control (Lane Keeping Assist System, hereinafter referred to as LKAS). The ACC is an example of vehicle speed control that controls the acceleration and deceleration of the ego vehicle 2 to control the vehicle speed of the ego vehicle 2. The travel controller 52 controls the propulsion device 3 and the brake device 4 to control the acceleration and deceleration of the ego vehicle 2 and assist the driver in driving. Further, the LKAS is an example of steering control that controls the steering device 5 to control the steering of the ego vehicle 2. The travel controller 52 controls the steering device 5 to control the trajectory of the ego vehicle 2 and assist the driver in driving.

The notifier 53 causes the display device 31 and/or the speaker 32 to notify the driver of information based on the detection results of the external environment recognizing device 7 or the like.

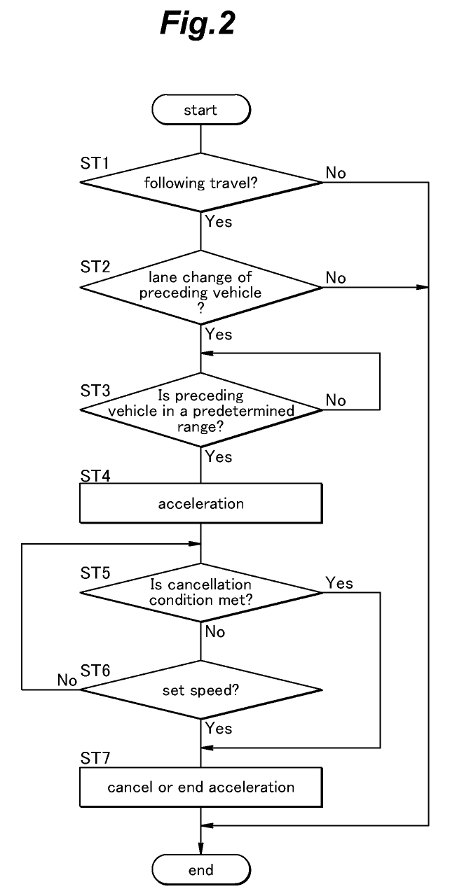

Next, with reference to FIGS. 1-5, one example of the procedure of the vehicle control performed by the vehicle control system 90 will be described. It is supposed here that the vehicle control device 1 is executing the ACC.

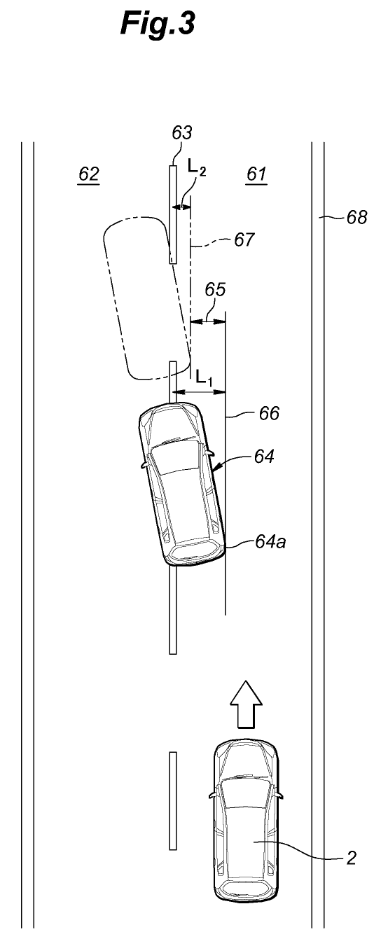

As shown in FIG. 3, the ego vehicle 2 is traveling on a first lane 61 of a road which includes the first lane 61 and a second lane 62. The first lane 61 and the second lane 62 are adjacent to each other and the boundary therebetween is defined by a lane marking 63. Ahead of the ego vehicle 2, there is a preceding vehicle 64 which is making a lane change from the first lane 61 to the second lane 62. In the present embodiment, when the preceding vehicle 64 makes a lane change during following travel of the ego vehicle 2, the vehicle control device 1 controls when and how to accelerate the ego vehicle 2 to make the ego vehicle 2 transition to the constant speed travel. The preceding vehicle 64 during a lane change includes a first lane-side end portion 64a, which is an end portion on the side of the first lane 61 in the road width direction. In the illustrated example, since the preceding vehicle 64 is changing lanes from the first lane 61 to the second lane 62 that is positioned on the left side of the first lane 61, the preceding vehicle 64 is directed obliquely leftward and forward, and the first lane-side end portion 64a is a right rear corner part of the preceding vehicle 64. To determine the position of the preceding vehicle 64 during a lane change, the vehicle control device 1 recognizes the first lane-side end portion 64a based on the detection results of the external environment recognizing device 7. The vehicle control device 1 recognizes the information related to the preceding vehicle 64 and the information related to the surrounding of the ego vehicle 2 based on the detection results of the external environment recognizing device 7. The external environment recognizing device 7 may include an inter-vehicle communication device and a navigation device. During the lane change, the first lane-side end portion 64a crossing a predetermined line corresponds to the entirety of the ego vehicle 2 crossing the predetermined line.

As shown in FIGS. 1-3, the vehicle control device 1 determines whether the following travel is being performed (ST1). The following travel means a state in which the preceding vehicle 64 traveling on the same lane as the ego vehicle 2 is traveling at a speed lower than a set speed of the ACC and the ego vehicle 2 is traveling at substantially the same speed as the preceding vehicle 64 while maintaining an appropriate inter-vehicle distance to the preceding vehicle 64 so as to follow the preceding vehicle 64. When the ego vehicle 2 is not performing the following travel (No in ST1), for example, when, even though there is a preceding vehicle 64, the speed of the preceding vehicle 64 is higher than the set speed and the ego vehicle 2 is traveling at a constant speed at the set speed, the vehicle control device 1 ends the process.

If the following travel is being performed (Yes in ST1), the vehicle control device 1 determines whether the preceding vehicle 64 has started a lane change (ST2). When, based on the detection results of the external environment recognizing device 7, the vehicle control device 1 recognizes blinking of the direction indicator 6 of the preceding vehicle 64 or recognizes movement of the preceding vehicle 64 toward the second lane 62, the vehicle control device 1 determines that the preceding vehicle 64 has started a lane change. In the case where the preceding vehicle 64 has not started a lane change (No in ST2), the vehicle control device 1 ends the process.

After the preceding vehicle 64 has started a lane change, the vehicle control device 1 does not perform acceleration control of the ego vehicle 2 before the first lane-side end portion 64a of the preceding vehicle 64 enters a predetermined range 65 set in the road width direction (lateral direction) (No in ST3), and controls the propulsion device 3 to accelerate the ego vehicle 2 (ST4) when the first lane-side end portion 64a of the preceding vehicle 64 is positioned within the predetermined range 65 (Yes in ST3). The predetermined range 65 is a range between a first determination line 66 which is spaced a first distance L1 shorter than a half of the width of the first lane 61 (the distance between the center lines of the two lane markings 63 and 68 defining the first lane 61) from the lane marking 63 on the side of the first lane 61 and a second determination line 67 which is spaced a second distance L2, which is greater than 0 and shorter than the first distance L1, from the lane marking 63 on the side of the first lane 61. Here, the distance from the lane marking 63 means the distance from the center line of the lane marking 63. Preferably, the vehicle control device 1 starts the acceleration of the ego vehicle 2 when the first lane-side end portion 64a of the preceding vehicle 64 moving toward the second lane 62 is positioned on the first determination line 66 or crosses the first determination line 66. Also preferably, the vehicle control device 1 determines that the lane change of the preceding vehicle 64 has substantially completed when the first lane-side end portion 64a of the preceding vehicle 64 moving toward the second lane 62 is positioned on the second determination line 67 or crosses the second determination line 67. Note that the first determination line 66 may be set at the center of the first lane 61 in the road width direction, and the second determination line 67 may be set on the lane marking 63. The term "within the predetermined range 65" may or may not include the positions on the first determination line 66 and the second determination line 67. For example, the length of the second distance L2 is 1/4 to 3/4, preferably 1/2, the length of the first distance L1.

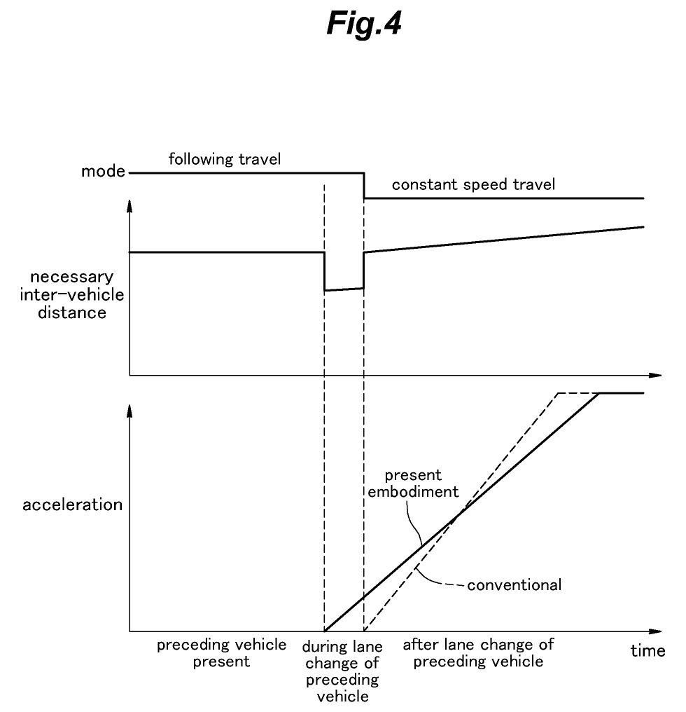

As shown in FIG. 4, conventionally, when even a part of the preceding vehicle 64 is positioned on the first lane 61, it is necessary to maintain the inter-vehicle distance during the following travel, and hence, acceleration is not performed. In the present embodiment, acceleration is started while a part of the preceding vehicle 64 is positioned on the first lane 61. Here, to avoid a situation where the acceleration cannot be performed due to difficulty of securing the necessary inter-vehicle distance to the preceding vehicle 64, the vehicle control device 1 sets the necessary inter-vehicle distance between the ego vehicle 2 and the preceding vehicle 64 shorter, for example, to a value 0.6 times the ordinary value, when the first lane-side end portion 64a of the preceding vehicle 64 enters the predetermined range 65. When the vehicle control device 1 determines that the lane change of the preceding vehicle 64 has substantially completed, the vehicle control device 1 returns the necessary inter-vehicle distance between the ego vehicle 2 and a newly detected preceding vehicle 64 to the ordinary value.

Further, preferably, the jerk (the rate of change of the acceleration, which is indicated by a tilt of the graph of the acceleration in FIG. 4) of the acceleration of the ego vehicle 2 started to be performed when the lane change of the preceding vehicle 64 is being performed is smaller than the jerk used in the acceleration when the ACC is started in a state in which the ego vehicle 2 is traveling at a speed lower than the set speed and there is no preceding vehicle 64 (the jerk in the conventional technology in which the acceleration is started after the lane change of the preceding vehicle 64 has completed). For example, the jerk of the former is 0.06 G/s, and the jerk of the latter is 0.1 G/s. Preferably, the acceleration of the ego vehicle 2 reaches an acceleration (about 0.03 G) with which the driver can feel the acceleration of the ego vehicle 2 while the first lane-side end portion 64a of the preceding vehicle 64 is positioned between the second determination line 67 and the lane marking 63.

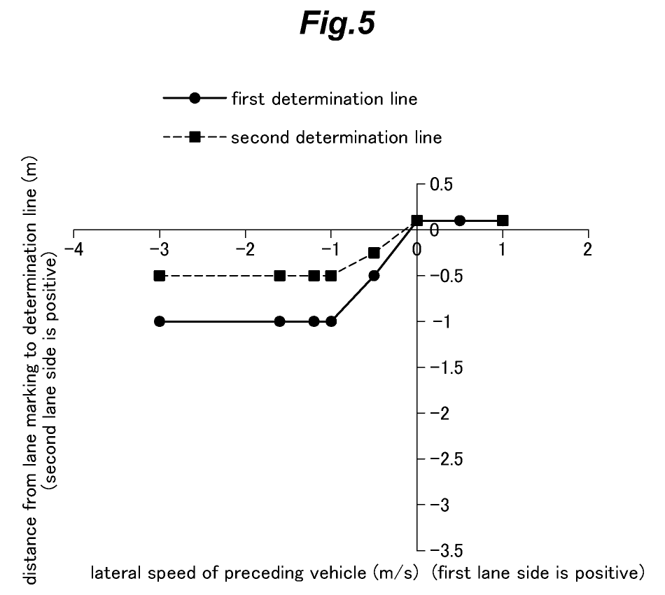

As shown in FIGS. 3 and 5, the positions of the first determination line 66 and the second determination line 67 are changed depending on the lateral speed (the speed in the road width direction) of the preceding vehicle 64. When the lateral speed of the preceding vehicle 64 is 0 or when the preceding vehicle 64 is moving away from the second lane 62, the preceding vehicle 64 is not making a lane change toward the second lane 62, and thus, the first determination line 66 and the second determination line 67 are set on the side of the second lane 62 with respect to the lane marking 63 (a right upper portion in FIG. 5). When the preceding vehicle 64 is moving toward the second lane 62, the first determination line 66 and the second determination line 67 are set to be more distant from the lane marking 63 on the side of the first lane 61 as the lateral speed toward the second lane 62 increases (a left lower portion in FIG. 5). Note that in FIG. 5, the direction of the lateral speed from the second lane 62 toward the first lane 61 is defined as positive, and the positions of the first determination line 66 and the second determination line 67 on the side of the second lane 62 with respect to the lane marking 63 are defined as positive. Therefore, when the lateral speed of the preceding vehicle 64 is negative, the values indicating the positions of the first determination line 66 and the second determination line 67 have negative values, and the less the lateral speed of the preceding vehicle 64 becomes, the less the values indicating the positions of the first determination line 66 and the second determination line 67 become. When the speed of the preceding vehicle 64 toward the second lane 62 becomes greater than or equal to a predetermined value (in the case where the direction toward the first lane 61 is defined as positive, when the lateral speed of the preceding vehicle 64 becomes less than or equal to a negative predetermined value, which is -1 m/s in the illustrated example), the positions of the first determination line 66 and the second determination line 67 become constant (in the illustrated example, the first determination line 66 is provided in a position spaced 1 m from the lane marking 63 on the side of the first lane 61, and the second determination line 67 is provided in a position spaced 0.5 m from the lane marking 63 on the side of the first lane 61). Note that when the lateral speed of the preceding vehicle 64 is small, namely, in a range of the lateral speed in which the positions of the first determination line 66 and the second determination line 67 are changed, the relative positions of the first determination line 66 and the second determination line 67 may be set such that the time from when the first lane-side end portion 64a of the preceding vehicle 64 crosses the first determination line 66 to when it reaches the second determination line 67 becomes a predetermined time (for example, about 0.2 seconds).

As shown in FIGS. 1-3, in the case where, after the acceleration of the ego vehicle 2, a cancellation condition is met (Yes in ST5) or the speed of the ego vehicle 2 reaches the set speed (Yes in ST6), the vehicle control device 1 cancels or ends the acceleration (ST7). The cancellation condition is met in such cases as when the preceding vehicle 64 shows a behavior from which it can be inferred that there is a high possibility that the preceding vehicle 64 will cancel the lane change and return to the first lane 61 or when a situation that may cause a collision with the preceding vehicle 64 unless the acceleration is cancelled arises. Specifically, a case where the first lane-side end portion 64a of the preceding vehicle 64 is positioned within the predetermined range 65 for a predetermined time (for example, 0.5 seconds) or more or a case where the preceding vehicle 64 decelerates with a predetermined magnitude or greater corresponds to the case where the cancellation condition is met. The vehicle control device 1 determines that the preceding vehicle 64 decelerates with a predetermined magnitude or greater and hence the cancellation condition is met when the preceding vehicle 64 decelerates at an acceleration less than or equal to a predetermined value (for example, an acceleration less than or equal to -0.25 G, where a negative value indicates deceleration) or when the speed of the preceding vehicle 64 is lowered from the maximum value during the lane change by a predetermined value or more or by a predetermined percentage or more.

Note that the acceleration of the ego vehicle 2 according to the vehicle control of the present embodiment is not performed or the acceleration may be cancelled in the following cases: (1) where the vehicle control device 1 cannot recognize the lane marking 63 based on the detection results of the external environment recognizing device 7; (2) where the speed of the ego vehicle 2 is slow (for example, less than or equal to 50 km/h); (3) where the inter-vehicle distance between the ego vehicle 2 and the preceding vehicle 64 is narrow (for example, less than or equal to 13 m); (4) where the time to collision of the ego vehicle 2 with the preceding vehicle 64 is less than or equal to a predetermined value (for example, less than or equal to 5 seconds); (5) where the width of the first lane 61 is narrow (for example, less than or equal to 3 m) so that if the first lane-side end portion 64a of the preceding vehicle 64 crosses the second determination line 67, the preceding vehicle 64 blocks the path of the ego vehicle 2; and (6) where the difference between the set vehicle speed and the speed of the ego vehicle 2 is small (for example, less than or equal to 5 km/h).

Also, in the case where the road on which the ego vehicle 2 is traveling is curved, the detection accuracy of the lane marking 63 by the external environment recognizing device 7 is lowered. In a situation in which the detection accuracy of the lane marking 63 is lowered as this, the vehicle control device 1 may calculate the positions of the first determination line 66 and the second determination line 67 by assuming that the lane marking 63 is positioned more on the side of the second lane 62 than the detected position.

Effects of the embodiment will be described in the following. Since the vehicle control device 1 starts the acceleration of the ego vehicle 2 before the first lane-side end portion 64a of the preceding vehicle 64 crosses the lane marking 63, the discomfort given to the driver is reduced compared to the case where the ego vehicle 2 is accelerated after the entirety of the preceding vehicle 64 crosses the lane marking 63. Also, in the case where the acceleration of the ego vehicle 2 is started when the first lane-side end portion 64a of the preceding vehicle 64 is positioned at the center of the first lane 61 in the road width direction or at a position closer to the lane marking 63 than the center of the first lane 61, the position of the preceding vehicle 64 recognized by the driver and the acceleration start timing of the ego vehicle 2 are harmonized with each other, whereby the discomfort felt by the driver due to too early start of acceleration is avoided and a situation that would require deceleration of the ego vehicle 2 after the start of acceleration to avoid collision with the preceding vehicle 64 can be prevented. By setting the first determination line 66 closer to the lane marking 63 than the center of the first lane 61 and setting the second determination line 67 between the lane marking 63 and the first determination line 66, the discomfort given to the driver is further reduced.

By setting the cancellation condition, in such cases as when the preceding vehicle 64 stops the lane change or takes a relatively long time for the lane change, a situation that would require rapid deceleration of the ego vehicle 2 to avoid collision with the preceding vehicle 64 can be prevented, whereby the driver's discomfort is reduced.

Since the jerk for the acceleration of the ego vehicle 2 caused by the lane change of the preceding vehicle 64 is smaller than the jerk used in the acceleration of the ego vehicle 2 when the ACC is started in the state in which there is no preceding vehicle 64, the driver is less likely to feel that the acceleration is performed abruptly, and a situation that would require rapid deceleration of the ego vehicle 2 to avoid collision with the preceding vehicle 64 can be prevented, whereby the driver's discomfort is reduced.

The embodiment may be modified in various ways without being limited to the above-described configuration. For example, the direction of the lane change of the preceding vehicle 64 may be the right direction, and the vehicle control of the above embodiment may be applied to the ego vehicle 2 travelling on a road having three or more lanes in each direction.

The above embodiment may be described as follows.

One embodiment of the present invention is a non-transitory computer-readable storage medium comprising a vehicle control program, wherein the vehicle control program, when executed by a computer (the vehicle control device 1) for controlling an ego vehicle 2, causes the computer to execute information processing including adaptive cruise control in which, when there is a preceding vehicle 64 traveling at a speed less than a predetermined set speed on a first lane 61 on which the ego vehicle 2 is traveling, following travel to follow the preceding vehicle 64 is performed, and when there is no preceding vehicle 64 on the first lane 61, constant speed travel to travel at the set speed is performed, wherein the information processing comprises an acceleration step in which, in a case where, during the following travel, the preceding vehicle 64 makes a lane change from the first lane 61 to a second lane 62 separated from the first lane 61 by a lane marking 63, the computer (the vehicle control device 1) accelerates the ego vehicle 2 to transition to the constant speed travel on the first lane 61 before an entirety of the preceding vehicle 64 crosses the lane marking 63.

According to this aspect, since the acceleration of the ego vehicle 2 is started before the preceding vehicle 64 crosses the lane marking 63 completely, the discomfort felt by the driver regarding the relationship between the position of the preceding vehicle 64 and when the acceleration of the ego vehicle 2 is started is reduced.

In the above configuration, preferably, the preceding vehicle 64 during the lane change includes a first lane-side end portion 64a which is an end portion on the side of the first lane 61 in a road width direction, and the acceleration step is started when the first lane-side end portion 64a of the preceding vehicle 64 is in a predetermined range 65 in the road width direction, the predetermined range 65 being a range between a center of the first lane 61 in the road width direction and the lane marking 63.

According to this aspect, the position of the preceding vehicle 64 recognized by the driver and the acceleration start timing of the ego vehicle 2 are harmonized with each other, and thus, the discomfort felt by the driver regarding the relationship between them can be reduced, and a situation in which the ego vehicle 2 decelerates to avoid collision with the preceding vehicle 64 after the acceleration of the ego vehicle 2 is started can be avoided.

In the above configuration, preferably, the predetermined range 65 is a range between a first determination line 66 which is spaced a first distance L1 shorter than a half of a width of the first lane 61 from the lane marking 63 on the side of the first lane 61 and a second determination line 67 which is spaced a second distance L2 shorter than the first distance L1 from the lane marking 63 on the side of the first lane 61.

According to this aspect, the position of the preceding vehicle 64 recognized by the driver and the acceleration start timing of the ego vehicle 2 are better harmonized with each other, and thus, the discomfort felt by the driver regarding the relationship between them can be more reduced, and a situation in which the ego vehicle 2 decelerates to avoid collision with the preceding vehicle 64 after the acceleration of the ego vehicle 2 is started can be avoided more reliably.

In the above configuration, preferably, the information processing comprises causing the computer (the vehicle control device 1) to cancel acceleration of the ego vehicle 2 in a case where, after the acceleration step is started, the first lane-side end portion 64a of the preceding vehicle 64 is positioned within the predetermined range 65 for a predetermined time or more.

According to this aspect, the acceleration of the ego vehicle 2 is cancelled when there is a high possibility that the lane change of the preceding vehicle 64 will be cancelled, and thus, a situation that would require rapid deceleration of the ego vehicle 2 to avoid collision with the preceding vehicle 64 can be prevented, whereby the driver's discomfort is reduced.

In the above configuration, preferably, the information processing comprises causing the computer (the vehicle control device 1) to cancel acceleration of the ego vehicle 2 in a case where, after the acceleration step is started, the preceding vehicle 64 performs deceleration of a predetermined magnitude or greater when the first lane-side end portion 64a of the preceding vehicle 64 is positioned within the predetermined range 65.

According to this aspect, a situation that would require rapid deceleration of the ego vehicle 2 to avoid collision with the preceding vehicle 64 can be prevented, whereby the driver's discomfort is reduced.

In the above configuration, preferably, a jerk in the acceleration step is smaller than a jerk used in an acceleration when the adaptive cruise control is started in a state in which the ego vehicle is traveling at a speed lower than the set speed and there is no preceding vehicle 64.

According to this aspect, the driver is less likely to feel that the acceleration is performed abruptly, and a situation that would require rapid deceleration of the ego vehicle 2 to avoid collision with the preceding vehicle 64 can be prevented, whereby the driver's discomfort is reduced.

One embodiment of the present invention is a vehicle control system 90 for controlling an ego vehicle 2 provided with a propulsion device 3, a brake device 4, and a steering device 5, the vehicle control system comprising: an external environment recognizing device 7 configured to detect an object around the ego vehicle 2; and a vehicle control device 1 configured to control the propulsion device 3, the brake device 4, and the steering device 5 based on information including detection results of the external environment recognizing device 7, wherein the vehicle control device 1 is configured to be capable of executing, in the ego vehicle 2, adaptive cruise control in which, when there is a preceding vehicle 64 traveling at a speed less than a predetermined set speed on a first lane 61 on which the ego vehicle 2 is traveling, following travel to follow the preceding vehicle 64 is performed, and when there is no preceding vehicle 64 on the first lane 61, constant speed travel to travel at the set speed is performed, and the vehicle control device 1 is configured such that in a case where, during the following travel, the preceding vehicle 64 makes a lane change from the first lane 61 to a second lane 62 separated from the first lane 61 by a lane marking 63, the vehicle control device 1 accelerates the ego vehicle 2 to transition to the constant speed travel on the first lane 61 before an entirety of the preceding vehicle 64 crosses the lane marking 63.

According to this aspect, since the acceleration of the ego vehicle 2 is started before the preceding vehicle 64 crosses the lane marking 63 completely, the discomfort felt by the driver regarding the relationship between the position of the preceding vehicle 64 and when the acceleration of the ego vehicle 2 is started is reduced.

1. A non-transitory computer-readable storage medium comprising a vehicle control program, wherein the vehicle control program, when executed by a computer for controlling an ego vehicle, causes the computer to execute information processing including adaptive cruise control in which, when there is a preceding vehicle traveling at a speed less than a predetermined set speed on a first lane on which the ego vehicle is traveling, following travel to follow the preceding vehicle is performed, and when there is no preceding vehicle on the first lane, constant speed travel to travel at the set speed is performed,
wherein the information processing comprises an acceleration step in which, in a case where, during the following travel, the preceding vehicle makes a lane change from the first lane to a second lane separated from the first lane by a lane marking, the computer accelerates the ego vehicle to transition to the constant speed travel on the first lane before an entirety of the preceding vehicle crosses the lane marking.

2. The non-transitory computer-readable storage medium according to claim 1, wherein the preceding vehicle during the lane change includes a first lane-side end portion which is an end portion on a side of the first lane in a road width direction, and
the acceleration step is started when the first lane-side end portion of the preceding vehicle is within a predetermined range in the road width direction, the predetermined range being a range between a center of the first lane in the road width direction and the lane marking.

3. The non-transitory computer-readable storage medium according to claim 2, wherein the predetermined range is a range between a first determination line which is spaced a first distance shorter than a half of a width of the first lane from the lane marking on the side of the first lane and a second determination line which is spaced a second distance shorter than the first distance from the lane marking on the side of the first lane.

4. The non-transitory computer-readable storage medium according to claim 2, wherein the information processing comprises causing the computer to cancel acceleration of the ego vehicle in a case where, after the acceleration step is started, the first lane-side end portion of the preceding vehicle is positioned within the predetermined range for a predetermined time or more.

5. The non-transitory computer-readable storage medium according to claim 2, wherein the information processing comprises causing the computer to cancel acceleration of the ego vehicle in a case where, after the acceleration step is started, the preceding vehicle performs deceleration of a predetermined magnitude or greater when the first lane-side end portion of the preceding vehicle is positioned within the predetermined range.

6. The non-transitory computer-readable storage medium according to claim 2, wherein a jerk in the acceleration step is smaller than a jerk used in an acceleration when the adaptive cruise control is started in a state in which the ego vehicle is traveling at a speed lower than the set speed and there is no preceding vehicle.

7. A vehicle control system for controlling an ego vehicle provided with a propulsion device, a brake device, and a steering device, the vehicle control system comprising:
an external environment recognizing device configured to detect an object around the ego vehicle; and
a vehicle control device configured to control the propulsion device, the brake device, and the steering device based on information including detection results of the external environment recognizing device,
wherein the vehicle control device is configured to be capable of executing, in the ego vehicle, adaptive cruise control in which, when there is a preceding vehicle traveling at a speed less than a predetermined set speed on a first lane on which the ego vehicle is traveling, following travel to follow the preceding vehicle is performed, and when there is no preceding vehicle on the first lane, constant speed travel to travel at the set speed is performed, and
the vehicle control device is configured such that in a case where, during the following travel, the preceding vehicle makes a lane change from the first lane to a second lane separated from the first lane by a lane marking, the vehicle control device accelerates the ego vehicle to transition to the constant speed travel on the first lane before an entirety of the preceding vehicle crosses the lane marking.
